(19) United States
(12) Patent Application Publication
(10) Pub. No.: US 2002/0178812 A1
(43) Pub. Date: Dec. 5, 2002

(54) Method for drying solid insulation for an electrical appliance

(76) Inventors: Paul Gmeiner, Oberwil-Lieli (CH); Steen Frydenlund Nielsen, Zurich (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/107,218

(22) Filed: Mar. 28, 2002

(30) Foreign Application Priority Data
Apr. 6, 2001 (EP) 01810345.7

(51) Int. Cl. F26B 3/00; G01M 1/16

(52) U.S. Cl. 73/468; 34/467; 34/443

(57) ABSTRACT

The method is used for drying solid insulation for an electrical appliance by means of the condensation heat emitted from the vapor of a solvent. When the solvent vapor condenses on the solid insulation, a vapor mixture is formed which contains solvent and water. This vapor mixture is supplied at a controlled flow rate from an evacuated autoclave to a condenser which is arranged outside the autoclave, and is condensed.

In order to keep the power required for this method low, the following method steps are carried out:

the amounts of solvent and water (Δm_{H2O}/Δt) produced in the condensate per unit time, and/or the amount of solvent produced per unit time, and the partial pressure of the water vapor (P_{H2O}) in the autoclave are measured,

a solvent nominal value curve (solventcontrol) is formed continuously from the measured values of the amount of water produced per unit time and/or of the water vapor partial pressure and from a process-specific assessment factor,

the measured values of the amount of solvent produced per unit time are compared continuously with values at associated times from the solvent nominal value curve, and

a control signal for operating an element for controlling the flow rate of the vapor mixture is emitted if the compared values differ from one another.

### FIELD OF THE INVENTION

The invention is based on a method for drying the solid insulation for an electrical appliance according to the common precharacterizing clause of patent claims 1 and 3.

In a method such as this, the condensation heat of a solvent vapor produced in an evaporator is used to quickly and safely heat the solid insulation of the electrical appliance, which is located in an autoclave that is kept at a reduced pressure. During the heating process, water which emerges from the solid insulation is supplied in a solvent/water vapor mixture to a condensation and separating apparatus, in which the vapor mixture is condensed and water is precipitated from the solvent/water condensate formed in the process.

Any insulating oil which may be present in the solid insulation is removed from the solid insulation by means of the condensed solvent. The solvent/insulating oil solution formed in this case is collected at the bottom of the autoclave. The solvent is removed from this solution by subsequent distillation, and the remaining insulating oil is removed from the apparatus.

### BACKGROUND OF THE INVENTION

A method of the type mentioned initially is described by P. K. Gmeiner in the company document MTV/E 02923000/22 “Modern vapour drying processes and plants” in particular on page 5, from Micafil Vakuumtechnik AG, Zurich. In this method, a solvent/water vapor mixture which is formed when solid insulation is heated in an evacuated autoclave is condensed outside the autoclave. The amount of vapor mixture removed from the autoclave per unit time is kept constant by means of a control valve which is arranged between the autoclave and a condenser. It is thus possible to assess the partial pressure of the water, and hence the progress of the drying process as well.

### SUMMARY OF THE INVENTION

The invention, as it is specified in the patent claims, is based on the object of reducing the power required for the method mentioned initially, using simple means.

The following method steps are carried out in the method according to the invention:

the amounts of solvent and water produced in the condensate per unit time, and/or the amount of solvent produced per unit time, and the partial pressure of the water vapor in the autoclave are measured,

a solvent nominal value curve is formed continuously from the measured values of the amount of water produced per unit time and/or of the water vapor partial pressure and from a process-specific assessment factor,

the measured values of the amount of solvent produced per unit time are compared continuously with values at associated times from the solvent nominal value curve, and

a control signal for operating an element for controlling the flow rate of the vapor mixture is emitted if the compared values differ from one another.

This means that the ratio of water vapor to solvent vapor is predetermined by the process-specific assessment factor and is in general largely constant, in the vapor mixture which is passed out of the autoclave, throughout the majority of the heating phase. A relatively small amount of vapor mixture is thus passed out of the autoclave. Little energy is thus lost in the condenser. Little energy is accordingly required to produce the vapor mixture.

It is recommended that the amount of water produced per unit time be measured using a level sensor or a flowmeter, since the values obtained in this way are highly accurate, and the method can then be controlled very exactly.

If the accuracy requirements are less stringent, then it is generally sufficient to measure the water vapor partial pressure in the autoclave instead of the rate at which water is produced. There is then no need for a water flowmeter.

A particularly high level of redundancy is achieved if both the amount of water and the water vapor partial pressure are measured.

The process-specific assessment factor is generally formed from empirically determined data before the start of the drying process, and is stored in a control and regulating apparatus. A nominal/actual value comparison can thus be carried out with sufficiently good accuracy using simple means.

If the outlet flow rate of the vapor mixture is controlled indirectly by varying the cooling in the condenser, then there is no need for any vapor control valve between the autoclave and the condenser. The condenser can then generally even be fitted directly on the autoclave, without any additional fitting aids.

In preferably simple embodiments, the cooling in the condenser is varied by controlling the flow rate of inert gas passing through the condenser, or by controlling the flow rate of the cooling water.

Additional energy is saved if the solvent produced in the condensate is fed back to an evaporator via a heat recuperator arranged in the autoclave.

### BRIEF DESCRIPTION OF THE DRAWINGS

The drawings show an exemplary embodiment of the invention in simplified form, and, to be precise,

FIG. 1 shows an outline scheme of one embodiment of the drying apparatus according to the invention, having an autoclave which holds the solid insulation to be dried and from which a solvent/water vapor mixture is passed out when the solid insulation is heated, and

FIG. 2 shows a graph illustrating the profile, with respect to time, of some of the parameters which are typical of operation of the apparatus shown in FIG. 1.

### DETAILED DESCRIPTION OF THE INVENTION

In the drying apparatus illustrated in the figure, 10 denotes an autoclave which can be heated and evacuated, and in which an evaporator 20 for a solvent and a heat recuperator 30 are arranged. The autoclave 10 also contains an object to be dried, for example an electrical appliance 40, such as a transformer, having hygroscopic solid insulation. The heat recuperator is connected via a pipeline 51 to a condenser 50. It can be connected via a pipeline 81 to a solvent feed pump 80, which carries solvent out of a separating tank 70.

The heat recuperator 30 is aligned vertically and has a boundary wall 31 which extends predominantly parallel to an autoclave side wall 11 and acts as a guide element. Together with the autoclave side wall 11, this wall bounds a space 32 which is in the form of a chute and is connected via an opening 33, located in the region of the autoclave base 1, to the interior of the autoclave, which contains the evaporator 20. The opening 33 is in the form of a slot and extends predominantly horizontally over the depth of the autoclave 10, which is governed by the side wall 11. At its upper end, the space 32 opens into the pipeline 51, which is passed to the exterior in a vacuum tight manner through the autoclave side wall 11. The space 32 is subdivided into two space elements which are arranged vertically one above the other and each contain a heat exchange path 34 or 35, respectively, for a heat-absorbing medium. The space element containing the path 34 is associated with a first stage 36 of the heat recuperator, and the space element containing the path 35 is associated with a second stage 37 of the heat recuperator. The lower end of each of the paths 34 and 35 interacts respectively with the pipeline 81, which is passed through the wall 11 in a vacuum tight manner, or with a pipeline 12, which is likewise passed through the wall 11 in a vacuum tight manner, while, in contrast, the upper end of the path 34 opens into that end of the pipeline 12 which enters the space 32, and the upper end of the path 35 opens into a pipeline 21 which leads to the evaporator 20. The paths 34 and 35 may, for example, be in the form of pipe sections. As indicated by dashed lines, the pipeline 21 may if required be passed in a vacuum tight manner through the autoclave wall to an external evaporator 22. This external evaporator can be connected to the autoclave 10 via a valve 23.

The condenser 50 is connected to the separating tank 70 via a flowmeter 54. The condenser 50 can furthermore be connected to a vacuum system 60 via a valve 53. The condenser 50 can also be connected to the vacuum system 60 via an inert gas control valve 61. There is also an inlet valve 62, which is connected to an inert gas source, in particular such as air or nitrogen, in this connection between an outlet from the condenser 50—or an outlet from the connection between the condenser 50 and the separating tank 70—and the control valve 61. A cooling water control valve 52 is arranged in a cooling water supply for the condenser 50.

The output signals from the flowmeter 54 and from a level sensor 71 provided on the separating tank 70 are supplied to a control and regulating apparatus 90. The control and regulating apparatus processes these signals, and forms control signals for the valves 52, 61 and 62.

The separating tank 70 has an outlet, which can be connected via the feed pump 80 to a solvent supply tank 82 or, optionally, to the pipeline 81. The connection for the solvent supply tank 82 can be produced via a valve 83, and that for the pipeline 81 can be produced via a valve 84. The pump 80 is followed by a flowmeter 85, whose measurement signals are supplied to the control and regulating apparatus 90.

An outlet is provided in the base of the autoclave 10, and can be connected via a feed pump 86 and a valve 87 either to the pipeline 12, or via the feed pump 86 and a valve 88 to a supply container for insulating oil, which has been washed out of the solid insulation as the solvent condenses.

A pressure measurement device 13 is also fitted to the autoclave and can determine the partial pressure of the water vapor located in the autoclave, and passes on appropriate signals to the control and regulating apparatus. 55 denotes a temperature sensor, which detects the temperature of the cooling water leaving the condenser 50.

This apparatus operates as follows:

In order to dry the solid insulation of the electrical appliance 40, the autoclave 10, in which the solid insulation is loaded, is first of all evacuated using the vacuum system 60. With the valve 53 closed, the evaporator 12 and/or the evaporator 22 produces solvent vapor, which condenses on the solid insulation, and thus heats it. At the same time, the condensed solvent dissolves the insulating oil or other impurities which may be present in the solid insulation. The solvent condensate, possibly containing oil, collects on the base of the evacuated autoclave and is pumped by the feed pump 86, with the valve 88 closed, via the open valve 87 and the pipeline 12 into the heat exchange path 35. The heating of the solid insulation 40 results in water vapor and any inert gases which there may be in the solid insulation entering the autoclave and forming a solvent/water vapor mixture with the solvent vapor, also containing any inert gases which may be present. This vapor mixture passes through the opening 33 into the space 32, which contains the heat exchange paths 34 and 35 of the heat recuperator 30, where it is passed upwards via the heat exchange paths and is finally sucked via the pipeline 51 into the condenser 50, in which it is deposited as solvent/water condensate. The inert gases which may be sucked out at the same time are passed via the condenser 50 and the control valve 61 into the vacuum system 60. Since the opening 33 extends into the interior of the autoclave 10 over its entire depth, the vapor mixture enters the heat recuperator 30 in linear form, rather than at a point. This results in a homogenous, large-area flow, thus allowing very good heat exchange.

Solvent and water are then obtained from the condensate in the separating tank 70. The solvent obtained in this way is fed, with the valve 83 closed, via the solvent feed pump 80, the open valve 84 and the pipeline 81 into the heat exchange path 34, which is provided in the first stage 36 of the heat recuperator 30, and in which it absorbs heat from the solvent/water vapor mixture, which acts as a heat-emitting medium. The solvent, preheated in this way, is supplied via the second stage 37 of the heat recuperator, or else directly, to the evaporator 20. Since the heat recuperator 30 is arranged in the autoclave, particularly little process heat is lost, and the condenser 50 may therefore be designed to be small. At the same time, effectively only that amount of energy which is required for heating the solid insulation need be supplied to the evaporator 20.

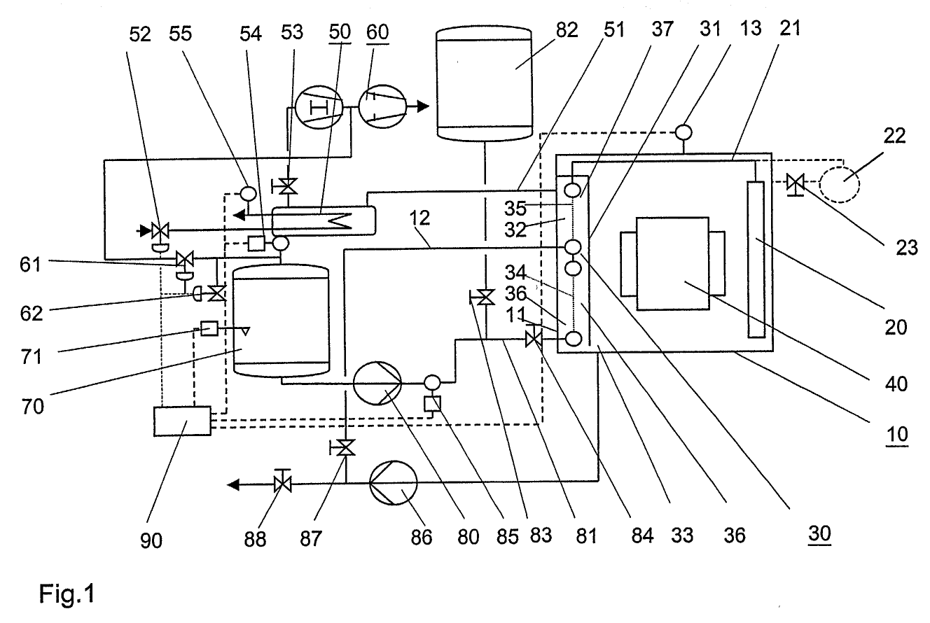

The efficiency of the drying process is particularly high if the condensate which collects on the base of the autoclave 10 when the valve 88 is closed is fed by means of the feed pump 86 via the open valve 87 and the pipeline 12 into the second stage 37 of the heat recuperator, and heat is absorbed from the vapor mixture in the heat exchange path 35. If, as is illustrated in FIG. 1, this condensate is carried together with the solvent, preheated in the first stage 36, into the second stage 37, then a particularly large amount of process heat can be obtained from the vapor mixture. The condensate heated in the second stage 37 and/or the solvent which is supplied from the first stage and has been additionally heated are supplied to the evaporator 20 and/or to the evaporator 22, where they are vaporized with little energy consumption.

A major advantage in this case is that, the installation of the heat recuperator in the autoclave 10 means that there is no need for any return lines or valves for the solvent which is formed in the heat recuperator 30 by condensation of the solvent/water vapor mixture, since the solvent which condenses in the heat recuperator 30 flows directly away into the autoclave 10. Since the evaporator 20 and the heat recuperator 30 are located in the autoclave, the solvent supply line 21 may be of simple design, that is to say in particular without any valves and without any vacuum bushings.

Furthermore the heat recuperator 30 does not need to be designed to be either vacuum tight or thermally insulated. For the reasons mentioned above, the heat recuperator 30 may be of simple design, and can be installed at easily accessible points in the autoclave. It is then easy to clean.

Process energy can initially be saved during the heating phase of the drying method if the rate at which the vapor mixture emerging from the autoclave 10 is returned is controlled as follows:

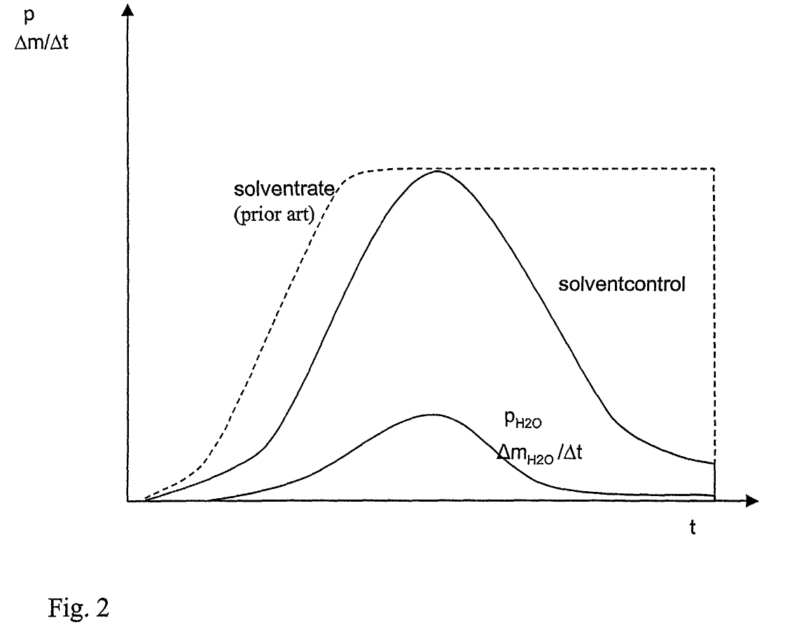

The amount of water Δm_{H2O}, for example in kg, produced in the drying process per unit time Δt, for example every 10 minutes, is determined using the level sensor 71 or a flowmeter (not illustrated) which determines the amount of water leaving the separating tank. A signal which is proportional to this rate of change Δm_{H2O}/Δt is supplied to the control and regulating apparatus 90. The time profile of this signal during the heating phase, that is to say the amount of water continuously removed from the autoclave per unit time during this time period, is illustrated in FIG. 2.

This signal is weighted in the control and regulating apparatus 90 by a predetermined assessment factor, which describes the number of solvent units required to remove a unit amount of water from the solid insulation 40. The assessment factor is dependent, inter alia, on the amount of solid insulation and the physical characteristics of the solvent, and can be determined empirically, for example by trial drying processes. The assessment factor during the heating phase is typically between 4 and 10. This results in a solvent nominal value curve, solventcontrol, as illustrated in FIG. 2. This solvent nominal value curve shows the desired value of the amount of solvent flowing back per unit time during the heating phase.

Alternatively or additionally, this solvent nominal value curve can also be determined by using a pressure measurement device 13 to measure the partial pressure P_{H2O} of the water vapor in the autoclave 10. A signal which is proportional to the water vapor partial pressure P_{H2O} is likewise weighted with the predetermined assessment factor in the control and regulating apparatus. This likewise results in the solvent nominal value curve, solventcontrol, illustrated in FIG. 2.

The amount of solvent flowing back is measured directly using the flowmeter 85, or else is determined indirectly via a flow measurement of the condensate passing into the separating tank 70, using the flowmeter 61. The measured or indirectly determined actual value is compared with the corresponding nominal value obtained from the solvent nominal value curve. If the actual value differs excessively from the nominal value, then the control and regulating apparatus 90 emits a command to a control element, which controls the amount of vapor mixture passing from the autoclave 10 into the condenser 50 such that the amount of solvent flowing back is matched to the solvent nominal value curve. The amount of vapor mixture that emerges from the autoclave 10 has until now been controlled such that the amount of condensate produced per unit time in the condenser 40 has been kept constant, once an initial phase has been passed through. The corresponding time profile of the solvent that is produced is shown by a dashed line in FIG. 2 (solvent return flow curve solventrate prior art).

The areas under the solvent nominal value curve solventcontrol and the solvent return flow curve solventrate, represented by a dashed line, according to the prior art are a measure of the amount of energy destroyed in the condenser 50 in the method according to the invention and in the method according to the prior art. The amount of energy defined by the difference between the area contents of the two curves is saved in the method according to the invention.

The inert gas control valve 61, which is contained in the connecting line from the condenser 50 to the vacuum system 60, is preferably provided for controlling the solvent return flow. By varying the inert gas pressure, this control valve governs the amount of condensate produced in the condenser 50, and hence the amount of solvent flowing back per unit time. There is thus no need for the otherwise normal control valve in the pipeline 51 between the autoclave 10 and the condenser 50. If too little inert gas is produced in the autoclave 10, or as a result of leakage losses, some additional inert gas can be let into the condenser 50 via the inlet valve 62, thus allowing the amount of condensate produced to be restricted.

Further advantageous control, since it is indirect, of the solvent return flow is achieved by controlling the cooling water for the condenser 50. To this end, the temperature sensor 55 is used to measure the temperature of the cooling water in the cooling water return flow, the measured temperature is monitored by the control and regulating apparatus 90 and, if a limit value is exceeded, a control command is emitted to the cooling water control valve 61, by means of which the cooling water inlet flow is varied. The amount of condensate produced in the condenser 50, and hence also the amount of solvent flowing back per unit time are controlled in this way. Furthermore, with this control system, there is no need for a vapor control valve between the autoclave and condenser. The method achieves particularly high redundancy by combining the cooling water control with the inert gas control.

List of reference symbols

| | |
|---|---|
| 10 | Autoclave |
| 11 | Autoclave wall |
| 12 | Pipeline |
| 13 | Partial pressure measurement device |
| 20 | Evaporator |
| 21 | Pipeline |
| 22 | Evaporator |
| 23 | Valve |
| 30 | Heat recuperator |
| 31 | Boundary wall |
| 32 | Space |
| 33 | Opening |
| 34, 35 | Heat exchange paths |
| 36, 37 | Stages |
| 40 | Electrical appliance with solid insulation |
| 50 | Condenser |
| 51 | Pipeline |
| 52 | Cooling water control valve |
| 53 | Valve |
| 54 | Flowmeter |
| 55 | Temperature sensor |
| 60 | Vacuum system |
| 61 | Control valve |
| 62 | Inert gas inlet valve |
| 70 | Separating tank |
| 71 | Level sensor |
| 80 | Solvent pump |
| 81 | Pipeline |
| 82 | Solvent supply tank |
| 83, 84 | Valves |
| 85 | Flowmeter |
| 86 | Feed pump |
| 87, 88 | Valves |
| 90 | Control and regulating apparatus |
| Δm_{H2O}/Δt | Amount of water produced per unit time |
| p_{H2O} | Water vapor partial pressure in the autoclave |

1. A method for drying solid insulation for an electrical appliance (40) by means of the condensation heat emitted from the vapor of a solvent, in which a vapor mixture containing solvent and water is formed in an autoclave (10) which holds the solid insulation and can be evacuated, and this vapor mixture is carried into a condenser (50), which is arranged outside the autoclave (10) at a controlled flow rate and is condensed, characterized in that the following method steps are carried out:
the amounts of solvent and water (Δm_{H2O}/Δt) produced in the condensate per unit time, and/or the amount of solvent produced per unit time, and the partial pressure of the water vapor (p_{H2O}) in the autoclave (10) are measured,
a solvent nominal value curve (solventcontrol) is formed continuously from the measured values of the amount of water produced per unit time and/or of the water vapor partial pressure and from a process-specific assessment factor,
the measured values of the amount of solvent produced per unit time are compared continuously with values at associated times from the solvent nominal value curve, and
a control signal for operating an element (52, 61, 62) for controlling the flow rate of the vapor mixture is emitted if the compared values differ from one another.

2. The method as claimed in claim 1, characterized in that the amount of water produced per unit time is measured using a level sensor (71) or a flowmeter.

3. The method as claimed in one of claim 1 or 2, characterized in that the process-specific assessment factor is formed from empirically determined data before the start of the drying process and is stored in a control and regulating apparatus (90).

4. The method as claimed in one of claims 1 to 3, characterized in that the outlet flow rate of the vapor mixture is controlled indirectly by varying the cooling power of the condenser (50).

5. The method as claimed in claim 4, characterized in that the cooling power of the condenser (50) is varied by controlling the flow rate of inert gas passed through the condenser (50).

6. The apparatus as claimed in claim 5, characterized in that inert gas is additionally supplied to the controlled inert gas from the exterior.

7. The apparatus as claimed in claim 6, characterized in that the additional inert gas is supplied via a controllable inlet valve (62).

8. The apparatus as claimed in one of claims 4 to 7, characterized in that the cooling power of the condenser (50) is varied by controlling the flow rate of cooling water.

9. The method as claimed in one of claims 1 to 8, characterized in that the solvent produced in the condensate is fed back to an evaporator (20, 22) via a heat recuperator (30) arranged in the autoclave (10).
